(19) United States
(12) Patent Application Publication
(10) Pub. No.: US 2017/0087052 A1
(43) Pub. Date: Mar. 30, 2017

(54) CPR Assistance Device, Intelligent Terminal, and CPR Assistance System

(71) Applicant: BOE Technology Group Co., Ltd., Beijing (CN)

(72) Inventor: Zhenfu Ma, Beijing (CN)

(73) Assignee: BOE Technology Group Co., Ltd., Beijing (CN)

(21) Appl. No.: 15/126,811

(22) PCT Filed: Nov. 27, 2015
(86) PCT No.: PCT/CN2015/095813

§ 371 Date: Sep. 16, 2016

(30) Foreign Application Priority Data
May 22, 2015 (CN) 201510266747.6

(51) Int. Cl. A61H 31/00; G08B 21/02

(52) U.S. Cl. CPC A61H 31/005; G08B 21/02; A61H 31/007

(57) ABSTRACT

This disclosure relate to a CPR assistance device, an intelligent terminal, and a CPR assistance system. The CPR assistance device is used to assist a rescuer in performing CPR, comprises a wearing bulk, and further comprises a compression information acquiring module (11) and a processing module (12); the compression information acquiring module (11) is provided on the wearing bulk, and configured to acquire a moving amplitude and/or an actual rate of moving of the wearing bulk when the rescuer performs a chest compression; the processing module (12) is connected with the compression information acquiring module (11), and can generate an amplitude and/or a rate control signal.

### TECHNICAL FIELD

Embodiments of the present disclosure relate to the field of medical assistance equipment, and more particularly, to a CPR assistance device, an intelligent terminal, and a CPR assistance system.

### BACKGROUND

Every year, sudden deaths only due to acute myocardial infarction and cardiac causes approximate to nearly one million cases nationwide in China, and deaths caused by electrocution, drowning, poisoning, traffic accidents, or other accidents are countless. CPR (Cardiopulmonary Resuscitation) is a key rescue measure taken for critical emergency patients whose breathing or heartbeat stops. As for a patient whose heartbeat stops, if initial CPR is performed within 4 minutes, and further heart rescuing is performed by professionals within 8 minutes, the patient is most likely to resurrect, so time is life, speed is crucial, and performing timely, correct CPR can greatly reduce mortality of various patients.

However, in real life, not everyone has the capability of performing correct CPR, when an emergency occurs, a survival rate of patients will be seriously affected by that CPR cannot be performed in time, how to assist a rescuer in performing correct CPR actions, and enable the public to perform correct CPR has become a technical problem that needs to be solved urgently.

### SUMMARY

The objectives of the embodiments of the present disclosure are to provide a CPR assistance device, an intelligent terminal, and a CPR assistance system, so as to assist the rescuer in performing correct CPR actions.

An embodiment of the present disclosure provides a CPR assistance device, the CPR assistance device is configured to assist a rescuer in performing CPR, comprises a wearing bulk, and further comprises a compression information acquiring module and a processing module;

the compression information acquiring module is provided on the wearing bulk, and configured to acquire a moving amplitude and/or an actual rate of moving of the wearing bulk when the rescuer performs a chest compression, so as to acquire a compression depth and/or a compression rate of the rescuer;

the processing module is connected with the compression information acquiring module, and configured to determine whether the moving amplitude of the wearing bulk is within a predetermined amplitude range, the processing module can generate an amplitude control signal when the moving amplitude of the wearing bulk is determined to be not within the predetermined amplitude range; and/or the processing module is configured to determine whether the actual rate is within a predetermined rate range, the processing module can generate a rate control signal when the actual rate is determined to be not within the predetermined rate range.

Exemplarily, the CPR assistance device further comprises an alerting module configured to issue an amplitude alert signal according to the amplitude control signal and/or issue a rate alert signal according to the rate control signal.

Exemplarily, the compression information acquiring module comprises:

an acceleration detecting unit configured to detect an acceleration of the wearing bulk when the rescuer is performing a chest compression;

a counting unit configured to perform statistics on a duration of each chest compression performed by the rescuer, and/or an interval between two adjacent chest compressions; and

a calculating unit connected with the acceleration detecting unit and the counting unit, respectively, and configured to calculate the moving amplitude of the wearing bulk according to the acceleration and the duration, and/or calculate the actual rate of moving of the wearing bulk according to the interval.

Exemplarily, the acceleration detecting unit comprises an acceleration sensor.

Exemplarily, the amplitude control signal comprises a first amplitude control signal and a second amplitude control signal, the processing module can generate the first amplitude control signal when the moving amplitude of the wearing bulk is determined to be smaller than a minimum of the predetermined amplitude range, and can generate the second amplitude control signal when the moving amplitude of the wearing bulk is determined to be bigger than a maximum of the predetermined amplitude range; and

the amplitude alert signal comprises a first amplitude alert signal corresponding to the first amplitude control signal and a second amplitude alert signal corresponding to the second amplitude control signal.

Exemplarily, the rate control signal comprises a first rate control signal and a second rate control signal, the processing module can generate the first rate control signal when the actual rate is determined to be smaller than a minimum of the predetermined rate range, and can generate the second rate control signal when the actual rate is determined to be bigger than a maximum of the predetermined rate range; and

the rate alert signal comprises a first rate alert signal corresponding to the first rate control signal and a second rate alert signal corresponding to the second rate control signal.

Exemplarily, the CPR assistance device further comprises a compression number statistics module, the compression number statistics module is connected with the processing module and configured to perform statistics on the number of times of compressions;

the processing module can determine whether the number of times of compressions reaches a predetermined number of times, when the number of times of compressions reaches the predetermined number of times, the processing module can generate an artificial respiration control signal; the alerting module can issue an artificial alert signal according to the artificial respiration control signal.

Exemplarily, the predetermined number of times is 30.

Exemplarily, the alerting module comprises any one or more of a display panel, a light emitting diode, an audio output element, and a vibration element.

Exemplarily, the wearing bulk is configured to be worn at the rescuer's hand or wrist.

Exemplarily, the wearing bulk comprises a bracelet or a ring.

Exemplarily, the CPR assistance device further comprises a first communication module configured to transmit the amplitude control signal and/or the rate control signal to a terminal capable of receiving a signal.

Correspondingly, an embodiment of the present disclosure further provides an intelligent terminal configured to acquire a heart position of a patient when a rescuer is performing CPR by using a CPR assistance device, wherein the CPR assistance device is any of the CPR assistance device described above, and the intelligent terminal comprises:

an image acquiring module configured to acquire body image information of the patient;

a heart position acquiring module configured to acquire a heart position in a body image according to the body image information, and generate a corresponding label signal; and

a display module configured to display the body image of the patient, and display a corresponding labeled image at the heart position of the body image.

Exemplarily, the intelligent terminal can receive the amplitude control signal and/or the rate control signal generated by the processing module of the CPR assistance device, and further comprises an alert signal generating module capable of generating an amplitude alert control signal according to the amplitude control signal, and/or a rate alert control signal according to the rate control signal,

the display module can generate a corresponding amplitude alert image according to the amplitude alert control signal, and/or generate a corresponding rate alert signal according to the rate control signal.

Exemplarily, the intelligent terminal further comprises a terminal bulk, within which the image acquiring module, the heart position acquiring module, and the display module are integrated, the terminal bulk further comprises a second communication module, the CPR assistance device further comprises a first communication module, communication can be made between the first communication module and the second communication module.

Exemplarily, the terminal bulk comprises a mobile phone, within which the image acquiring module, the heart position acquiring module, and the display module are integrated; or

the terminal bulk comprises a spectacle frame, on which the image acquisition module, the heart position acquisition module, and the display module are integrated; or

the terminal bulk comprises a helmet, on which the image acquiring module, the heart position acquiring module, and the display module are integrated.

Correspondingly, an embodiment of the present disclosure further provides a CPR assistance system, comprising any of the CPR assistance device described above and any of the intelligent terminal described above.

In the embodiments of the present disclosure, with the CPR assistance device, the compression depth and the compression rate of the rescuer can be acquired, and the amplitude control signal and the rate control signal can be generated to enable the alerting module or the intelligent terminal to issue an alert signal, so that the rescuer can adjust compression actions according to the alert signal, until the compression depth and the compression rate meet requirements of CPR standards, which thereby improves effectiveness of CPR, as a result, more people can perform CPR rescue by using the CPR assistance device; and the intelligent terminal can assist the rescuer in determining a heart position, which further improves accuracy and rescue effectiveness when laypersons perform CPR.

### BRIEF DESCRIPTION OF THE DRAWINGS

The drawings are to provide a further understanding of the embodiments of the present disclosure, and constitute a portion of the specification, they are for explaining the present disclosure together with the specific implementations provided below, and do not function as limiting the present disclosure. In the drawings:

FIG. 1 is a schematic diagram of structure of modules of the CPR assistance device in an embodiment of the present disclosure; and

FIG. 2 is a schematic diagram of structure of modules when the CPR assistance device and the intelligent terminal are connected in an embodiment of the present disclosure.

Reference signs are as follows:

11, compression information acquiring module; 111, acceleration detecting unit; 112 calculating unit; 113, counting unit; 12, processing module; 13, alerting module; 14, compression number statistics module; 15, first communication module; 20, intelligent terminal; 21, image acquiring module; 22, heart position acquiring module; 23, display module; 24, alert signal generating module; 25, second communication module.

### DETAILED DESCRIPTION OF THE EMBODIMENTS

Hereinafter, the specific implementations of the present disclosure will be described in detail with reference to the drawings. It should be understood that the specific implementations described herein are only intended to illustrate and explain the present disclosure, rather than to make limitations to the present disclosure.

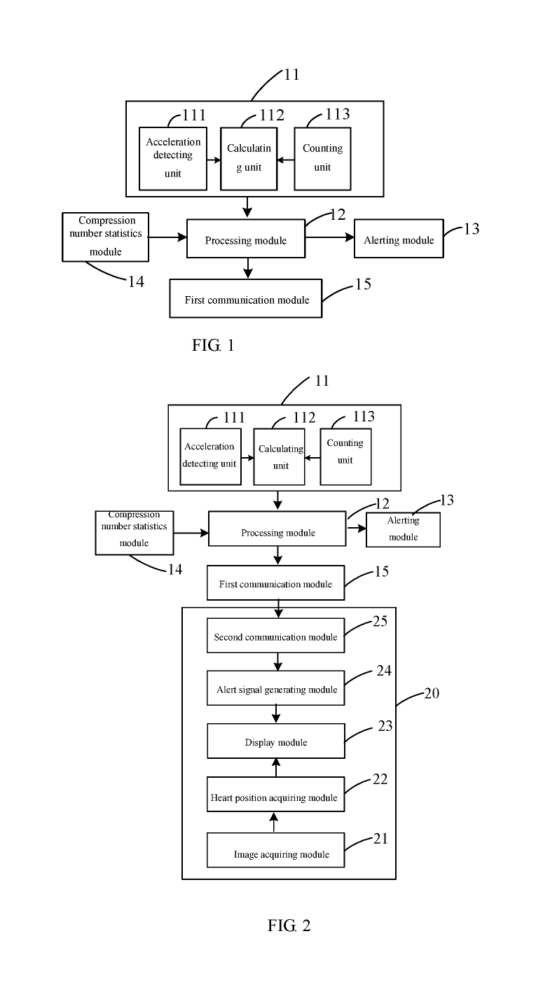

As an embodiment of the present disclosure, there is provided a CPR assistance device configured to assist a rescuer in performing CPR, the CPR assistance device comprises a wearing bulk, as shown in FIG. 1, and further comprises a compression information acquiring module 11 and a processing module 12;

the compression information acquiring module 11 is provided on the wearing bulk, and configured to acquire a moving amplitude and/or an actual rate of moving of the wearing bulk when the rescuer performs a chest compression, so as to acquire a compression depth and/or a compression rate of the rescuer;

the processing module 12 is connected with the compression information acquiring module 11, and configured to determine whether the moving amplitude of the wearing bulk is within a predetermined amplitude range, the processing module 12 can generate an amplitude control signal when the moving amplitude of the wearing bulk is determined to be not within the predetermined amplitude range; and/or the processing module is configured to determine whether the actual rate is within a predetermined rate range, the processing module 12 can generate a rate control signal when the actual rate is determined to be not within the predetermined rate range.

In an embodiment of the present disclosure, the compression information acquiring module 11 may acquire only a moving amplitude of the wearing bulk when the rescuer is performing a chest compression, correspondingly, the processing module 12 may determine whether the moving amplitude of the wearing bulk is within a predetermined amplitude range, and generate an amplitude control signal; or, the compression information acquiring module 11 may acquire only a moving rate of the wearing bulk, correspondingly, the processing module 12 may determine whether the moving rate is within a predetermined rate range, and generate a rate control signal; or the compression information acquiring module 11 may acquire both a moving amplitude of the wearing bulk and a moving rate of the wearing bulk, in this case, the processing module 12 may determine the moving amplitude and the moving rate of the wearing bulk, respectively.

The CPR rescue method requires that a proper compression depth and a proper compression rate must be achieved when chest compressions are performed on the patient. For most laypersons, they are not familiar with the use of the CPR rescue method, and are unable to determine whether the compression strength or the compression rate is proper, so that the compression depth and the compression rate are not standard enough.

In the CPR assistance device provided in the embodiment of the present disclosure, when the rescuer wears the wearing bulk to perform chest compressions on the patient, the compression information acquiring module can acquire the moving amplitude of the wearing bulk so as to acquire the compression depth, the processing module 12 can compare the moving amplitude of the wearing bulk with a predetermined amplitude range, when the moving amplitude of the wearing bulk is not within the predetermined amplitude range, the processing module 12 generates an amplitude control signal, which may be transmitted to a terminal such as a mobile phone or other receiving module, so as to generate a corresponding amplitude alert signal on the terminal or the receiving module, and the rescuer can learn that the compression strength is not proper according to this amplitude alert signal, so as to facilitate the rescuer further adjusting the compression strength, until the moving amplitude of the wearing bulk is within the predetermined amplitude range; likewise, when the compression information acquiring module 11 acquires an actual rate of the wearing bulk, the processing module 12 can compare the actual rate with a predetermined rate range, when the actual rate is not within the predetermined rate range, the processing module 12 can transmit a rate control signal to the terminal or other receiving module, so that the terminal or the other receiving module issues a rate alert signal, the rescuer can learn that the compression rate is not proper according to this rate alert signal, so as to so as to facilitate the rescuer further adjusting the compression rate, until the actual rate is within the predetermined amplitude range. In a supporting role of the CPR assistance device, it is possible to assist more people in performing CRP rescue with correct compression actions, thereby give first aid to critical emergency patients whose breathing or heartbeat stops, improve a possibility that the critical patients can restore a heartbeat, and save more lives.

The “connected” in the present disclosure may refer to a connection in way of a signal line, or may be a wireless connection.

As described above, the magnitude control signal and/or the rate control signal generated by the processing module 12 may be transmitted to a terminal such as a mobile phone or other receiving module, as a specific implementation mode, as shown in FIG. 1, the CPR assistance device may further comprise an alerting module 13, the alerting module is configured to issue an amplitude alert signal according to the amplitude control signal and/or issue a rate alert signal according to the rate control signal. Through the amplitude alert signal and/or the rate alert signal issued by the alerting module 13, the rescuer can intuitively learn whether his/her rescue actions are standard.

Specifically, as shown in FIG. 1, the compression information acquiring module 11 comprises:

an acceleration detecting unit 111 configured to detect an acceleration a of the wearing bulk when the rescuer is performing a chest compression;

a counting unit 113 configured to perform statistics on a duration t1 of each chest compression performed by the rescuer, and/or an interval t2 between two adjacent chest compressions; and

a calculating unit 112 connected with the acceleration detecting unit 111 and the counting unit 113, respectively, and configured to calculate the moving amplitude of the wearing bulk according to the acceleration a and the duration t1, and/or calculate the actual rate of moving of the wearing bulk according to the interval t2.

Each compression mentioned above refers to, from that the rescuer's hand is placed on the patient's chest and starts to compress, until the patient's chest is compressed to the lowest point. During each compression, the rescuer's arm begins to exert a force from a static state so as to compress the patient's chest, when the chest is compressed to the lowest point, a speed of the rescuer's arm is back to zero, that is, both an initial speed and a final speed of the wearing bulk during each compression are zero, thus, the moving amplitude of the wearing bulk, i.e., the compression depth on the patient's chest, can be calculated through the acceleration of the compression bulk and the duration of one compression.

When it needs to acquire the actual rate of moving of the wearing bulk, the counting unit 113 may be used to perform statistics on the interval t2 between two adjacent compressions, that is, an interval between two times when the chest is compressed to the lowest point, and the calculating unit calculates the actual rate of moving of the wearing bulk, i.e., the compression rate of the rescuer, according to the interval.

Further, the acceleration detecting unit 111 comprises an acceleration sensor.

As will be appreciated, when the rescuer is performing a chest compression on the patient, the patient remains a gesture of lying flat, a pressure of compression vertically acts on the chest cavity, i.e., along a vertical direction. The moving amplitude acquired by the compression information acquiring module is a moving amplitude in the vertical direction.

Exemplarily, the predetermined amplitude range and the predetermined rate range may be determined based on the compression depth and the compression rate specified in international guidelines and standards for CPR and ECC (Emergency Cardiovascular Care).

In order to facilitate the rescuer adjusting the compression actions, further, the amplitude control signal comprises a first amplitude control signal and a second amplitude control signal, the processing module 12 can generate the first amplitude control signal when the moving amplitude of the wearing bulk is determined to be smaller than a minimum of the predetermined amplitude range, and can generate the second amplitude control signal when the moving amplitude of the wearing bulk is determined to be bigger than a maximum of the predetermined amplitude range; and the amplitude alert signal comprises a first amplitude alert signal corresponding to the first amplitude control signal and a second amplitude alert signal corresponding to the second amplitude control signal.

Accordingly, when the alerting module 13 issues the first amplitude alert signal, the rescuer can learn that the compression depth is relatively small, and further enhance the compression strength to increase the moving amplitude of the wearing bulk; when the alerting module 13 issues the second amplitude alert signal, the rescuer can learn that the compression depth is relatively large, and further reduce the compression strength to decrease the moving amplitude of the wearing bulk.

When the compression information acquiring module 11 can acquire the actual rate of moving of the wearing bulk, the rate control signal issued by the processing module 12 may comprise a first rate control signal and a second rate control signal, the processing module 12 can generate the first rate control signal when the actual rate is determined to be smaller than a minimum of the predetermined rate range, and can generate the second rate control signal when the actual rate is determined to be bigger than a maximum of the predetermined rate range. Correspondingly, the rate alert signal issued by the alerting module 13 comprises a first rate alert signal corresponding to the first rate control signal and a second rate alert signal corresponding to the second rate control signal.

Therefore, when the alerting module 13 issues a first amplitude alert signal, the rescuer can learn that the compression rate is relatively low, thereby increase the compression rate (i.e., accelerate the compression speed); when the alerting module 13 issues the second amplitude alert signal, the rescuer can learn that the compression rate is relatively high, and thereby reduce the compression rate (i.e., decrease the compression speed).

When performing CPR rescue, chest compression and artificial respiration need to be performed concurrently, artificial respiration must be performed on the patient after making a certain number of chest compressions.

Further, the CPR assistance device further comprises a compression number statistics module 14, the compression number statistics module 14 is connected with the processing module 12 and configured to perform statistics on the number of times of compressions;

the processing module 12 can determine whether the number of times of compressions reaches a predetermined number of times, when the number of times of compressions reaches the predetermined number of times, the processing module 12 can generate an artificial respiration control signal; the alerting module can issue an artificial alert signal according to the artificial respiration control signal.

When the alerting module 13 issues the artificial respiration alert signal, it may begin artificial respiration on the patient.

For example, the predetermined number of times is 30. In real life, not everyone knows a specific number of chest compressions that need to be performed before artificial respiration during the CPR rescue process, rescue effectiveness of CPR can be improved in a prompting role of the alerting module 13.

In an embodiment of the present disclosure, the alerting module 13 may have a variety of structural forms. For example, the alerting module 13 may comprise any one or more of a display panel, a light emitting diode, an audio output element, and a vibration element. When the alerting module 13 comprises the display panel, the amplitude alert signal, the rate alert signal, and the artificial respiration alert signal described above are an image signal each, for example, the image signal is a text image, the display panel displays a different text to represent a different alert signal. When the alerting module 13 comprises the light emitting diode, a different alert signal may be represented with a light emitting diode of a different color. When the alerting module 13 comprises an audio output element, the audio output element may output a different audio signal to represent a different alert signal. When the alerting module comprises a vibration element, a different alert signal may be represented by a different vibration frequency.

As will be appreciated, the CPR assistance device may further comprise a storage module, respective alert signals issued by the alerting module 13 may be stored in the storage module in advance, the processing module can directly output an alert signal that needs to be outputted through the alerting module.

In an embodiment of the present disclosure, the wearing bulk is configured to be worn at the rescuer's hand or wrist, thus the compression depth or the compression rate of the rescuer can be acquired directly by acquiring the moving magnitude and/or the actual rate of moving of the wearing bulk.

For example, the wearing bulk may comprise a bracelet or a ring, the compression information acquiring module 11, the processing module 12, and the alerting module 13 may be all provided on the wearing bulk, so as to facilitate wearing and carrying of the rescuer without affecting the compression actions of the rescuer.

As described above, the amplitude control signal and the rate control signal generated by the processing module 12 may be transmitted to a terminal such as a mobile phone. For example, the CPR assistance device may further comprise a first communication module 15 configured to transmit the amplitude control signal and/or the rate control signal to a terminal capable of receiving a signal. The terminal may generate a corresponding amplitude alert signal and/or a rate alert signal. When the wearing bulk is an amounting bulk having a relatively small size such as a bracelet or a ring, generating an amplitude alert signal and a rate alert signal by using a terminal may require no alerting module, such as a display panel, provided on the wearing bulk, so as to simplify structure of the CPR assistance device.

As another embodiment of the present disclosure, there is provided an intelligent terminal 20 configured to acquire a heart position of a patient when a rescuer is performing CPR by using any of CPR assistance device described above, as shown in FIG. 2, the intelligent terminal 20 comprises:

an image acquiring module 21 configured to acquire body image information of the patient;

a heart position acquiring module 22 configured to acquire a heart position in a body image according to the body image information, and generate a corresponding label signal; and

a display module 23 configured to display the body image of the patient, and display a corresponding labeled image at the heart position of the body image.

It can be determined by laypersons that when performing CPR, the patient needs to lie flat in a horizontal plane. In this case, a body image of the patient can be acquired by the image acquiring module 21, and the heart position acquiring module 22 can acquire a heart position in the body image according to an outline of the body image, and a proportion of respective body parts.

For example, the image acquiring module 21 may be a camera, body image information acquired by this camera is position coordinates of respective points within its field of view and associated grayscale values, the heart position acquiring module 22 may acquire coordinates at the heart position, and may set grayscales at the coordinates as predetermined grayscale values, in this way, when the display module 23 displays a body image, an image at the heart position is represented with a predetermined color.

The rescuer can easily, accurately determine the heart position according to the body image and the marked image displayed by the display module, which facilitates performing CPR rescue.

As described above, the amplitude control signal and/or the rate control signal generated by the processing module 12 of the CPR assistance device may be transmitted to a terminal such as a mobile phone, so that the terminal such as a mobile phone can issue an alert signal.

For example, the intelligent terminal 20 can receive the amplitude control signal and/or the rate control signal generated by the processing module of the CPR assistance device, as shown in FIG. 2, the intelligent terminal 20 may further comprise an alert signal generating module 24 capable of generating an amplitude alert control signal according to the amplitude control signal, and/or a rate alert control signal according to the rate control signal, the display module 23 can generate a corresponding amplitude alert image according to the amplitude alert control signal, and/or generate a corresponding rate alert image according to the rate control signal. The rescuer can intuitively learn whether the compression strength and the compression rate are standard according to the alert image, so as to facilitate adjusting the compression strength and the compression rate.

As will be appreciated, in the CPR assistance device described above, the rate alert signal and the amplitude alert signal each are a signal that can be intuitively perceived by people, for example, an optical signal, an image signal, a sound signal and so on, the amplitude alert control signal and the rate alert control signal generated by the alert signal generating module 24 each are an analog signal or a digital signal used to control, and cannot be perceived by people.

For example, the intelligent terminal may further comprise a terminal bulk, within which the image acquiring module, the heart position acquiring module, and the display module are integrated, the terminal bulk further comprises a second communication module 25, the CPR assistance device further comprises a first communication module 15, communication can be made between the first communication module 15 and the second communication module 25, and for example, the first communication module 15 and the second communication module 25 may be wirelessly connected via Bluetooth.

As shown in FIG. 2, the amplitude control signal and the rate control signal generated by the processing module 12 of the CPR assistance device may be transmitted to the intelligent terminal via the first communication module 15 and the second communication module 25, the amplitude alert control signal and the rate alert control signal generated by the alert signal generating module 24 may control the display module to generate the corresponding amplitude alert image and the rate alert image.

The terminal bulk may have different structural forms. For example, the intelligent terminal comprises a mobile phone, within which the image acquiring module 21, the heart position acquiring module 22, and the display module 23 are integrated; or the terminal bulk comprises a spectacle frame, on which the image acquisition module 21, the heart position acquisition module 22, and the display module 23 are integrated; or the terminal bulk comprises a helmet, on which the image acquiring module 21, the heart position acquiring module 22, and the display module 23 are integrated. The intelligent terminal may be used as daily appliance, but when CPR rescue needs to be performed, the heart position may also be acquired via the mobile phone to assist in performing CPR.

As a third embodiment of the present disclosure, there is provided a CPR assistance system, comprising any of the CPR assistance device described above and any of the intelligent terminal provided above. The rescuer uses the CPR assistance device and the intelligent terminal concurrently to perform CPR. That is to say, the heart position is determined by using the intelligent terminal, and the compression actions are adjusted according to an alert signal provided by the CPR assistance device while performing CPR and artificial respiration.

In the embodiment of the present disclosure, the rescuer can adjust the compression actions according to an alert from the CPR assistance device when performing chest compressions, until the compression depth and the compression rate meet requirements of CPR standards, which thereby improves effectiveness of CPR, as a result, more people can perform CPR rescue by using the CPR assistance device; and the intelligent terminal can assist the rescuer in determining a heart position, which further improves accuracy and rescue effectiveness when laypersons perform CPR.

As will be appreciated, the above implementations merely are exemplary implementations adopted to illustrate the principles of the present disclosure, and the present disclosure is not limited to those described implementations. A person of ordinary skill in the art can make various modifications and variations to the present disclosure without departing from the spirit and scope thereof. The present disclosure is also intended to include these modifications and variations.

The present application claims priority of the Chinese Patent Application No. 201510266747.6 filed on May 22, 2015, the entire disclosure of which is hereby incorporated in full text by reference as part of the present application.

1. A CPR assistance device configured to assist a rescuer in performing CPR, comprises a wearing bulk, a compression information acquiring module and a processing module;
the compression information acquiring module is provided on the wearing bulk, and configured to acquire a moving amplitude and/or an actual rate of moving of the wearing bulk when the rescuer performs a chest compression, so as to acquire a compression depth and/or a compression rate of the rescuer;
the processing module is connected with the compression information acquiring module, and configured to determine whether the moving amplitude of the wearing bulk is within a predetermined amplitude range, the processing module can generate an amplitude control signal when the moving amplitude of the wearing bulk is determined to be not within the predetermined amplitude range; and/or the processing module is configured to determine whether the actual rate is within a predetermined rate range, the processing module can generate a rate control signal when the actual rate is determined to be not within the predetermined rate range.

2. The CPR assistance device according to claim 1, further comprising an alerting module configured to issue an amplitude alert signal according to the amplitude control signal and/or issue a rate alert signal according to the rate control signal.

3. The CPR assistance device according to claim 2, wherein the compression information acquiring module comprises:
an acceleration detecting unit configured to detect an acceleration of the wearing bulk when the rescuer is performing a chest compression;
a counting unit configured to perform statistics on a duration of each chest compression performed by the rescuer, and/or an interval between two adjacent chest compressions; and
a calculating unit connected with the acceleration detecting unit and the counting unit, respectively, and configured to calculate the moving amplitude of the wearing bulk according to the acceleration and the duration, and/or calculate the actual rate of moving of the wearing bulk according to the interval.

4. The CPR assistance device according to claim 3, wherein the acceleration detecting unit comprises an acceleration sensor.

5. The CPR assistance device according to claim 2, wherein the amplitude control signal comprises a first amplitude control signal and a second amplitude control signal, the processing module can generate the first amplitude control signal when the moving amplitude of the wearing bulk is determined to be smaller than a minimum of the predetermined amplitude range, and can generate the second amplitude control signal when the moving amplitude of the wearing bulk is determined to be bigger than a maximum of the predetermined amplitude range; and
the amplitude alert signal comprises a first amplitude alert signal corresponding to the first amplitude control signal and a second amplitude alert signal corresponding to the second amplitude control signal.

6. The CPR assistance device according to claim 2, wherein the rate control signal comprises a first rate control signal and a second rate control signal, the processing module can generate the first rate control signal when the actual rate is determined to be smaller than a minimum of the predetermined rate range, and can generate the second rate control signal when the actual rate is determined to be bigger than a maximum of the predetermined rate range; and
the rate alert signal comprises a first rate alert signal corresponding to the first rate control signal and a second rate alert signal corresponding to the second rate control signal.

7. The CPR assistance device according to claim 2, wherein the CPR assistance device further comprises a compression number statistics module, the compression number statistics module is connected with the processing module and configured to perform statistics on the number of times of compressions;
the processing module can determine whether the number of times of compressions reaches a predetermined number of times, when the number of times of compressions reaches the predetermined number of times, the processing module can generate an artificial respiration control signal; the alerting module can issue an artificial alert signal according to the artificial respiration control signal.

8. The CPR assistance device according to claim 7, wherein the predetermined number of times is 30.

9. The CPR assistance device according to claim 2, wherein the alerting module comprises any one or more of a display panel, a light emitting diode, an audio output element, and a vibration element.

10. The CPR assistance device according to claim 1, wherein the wearing bulk is configured to be worn at the rescuer's hand or wrist.

11. The CPR assistance device according to claim 10, wherein the wearing bulk comprises a bracelet or a ring.

12. The CPR assistance device according to claim 1, further comprising a first communication module configured to transmit the amplitude control signal and/or the rate control signal to a terminal capable of receiving a signal.

13. An intelligent terminal configured to acquire a heart position of a patient when a rescuer is performing CPR by using a CPR assistance device, wherein the CPR assistance device is the CPR assistance device according to claim 1, and the intelligent terminal comprises:
an image acquiring module configured to acquire body image information of the patient;
a heart position acquiring module configured to acquire a heart position in a body image according to the body image information, and generate a corresponding label signal; and
a display module configured to display the body image of the patient, and display a corresponding labeled image at the heart position of the body image.

14. The intelligent terminal according to claim 13, wherein the intelligent terminal can receive the amplitude control signal and/or the rate control signal generated by the processing module of the CPR assistance device, and further comprises an alert signal generating module capable of generating an amplitude alert control signal according to the amplitude control signal, and/or a rate alert control signal according to the rate control signal,
the display module can generate a corresponding amplitude alert image according to the amplitude alert control signal, and/or generate a corresponding rate alert signal according to the rate control signal.

15. The intelligent terminal according to claim 13, wherein the intelligent terminal further comprises a terminal bulk, within which the image acquiring module, the heart position acquiring module, and the display module are integrated, the terminal bulk further comprises a second communication module, the CPR assistance device further comprises a first communication module, communication can be made between the first communication module and the second communication module.

16. The intelligent terminal according to claim 15, wherein the terminal bulk comprises a mobile phone, within which the image acquiring module, the heart position acquiring module, and the display module are integrated; or
the terminal bulk comprises a spectacle frame, on which the image acquisition module, the heart position acquisition module, and the display module are integrated; or
the terminal bulk comprises a helmet, on which the image acquiring module, the heart position acquiring module, and the display module are integrated.

17. A CPR assistance system, comprising:
A CPR assistance device configured to assist a rescuer in performing CPR, comprises a wearing bulk, a compression information acquiring module and a processing module;
the compression information acquiring module is provided on the wearing bulk, and configured to acquire a moving amplitude and/or an actual rate of moving of the wearing bulk when the rescuer performs a chest compression, so as to acquire a compression depth and/or a compression rate of the rescuer;
the processing module is connected with the compression information acquiring module, and configured to determine whether the moving amplitude of the wearing bulk is within a predetermined amplitude range; the processing module can generate an amplitude control signal when the moving amplitude of the wearing bulk is determined to configured to determine whether the actual rate is within a predetermined rate range the processing module can generate a rate control signal when the actual rate is determined to be not within the predetermined rate range, and the intelligent terminal according to claim 13.
